(19) United States
(12) Patent Application Publication
(10) Pub. No.: US 2024/0311436 A1
(43) Pub. Date: Sep. 19, 2024

(54) DISPLAYING BROWSER HISTORY IN A USER INTERFACE

(71) Applicant: GOOGLE LLC, Mountain View, CA (US)

(72) Inventors: Daniel Peng, Seattle, WA (US); Yana Yushkina, Seattle, WA (US); Tarun Bansal, Bellvue, WA (US); Sophie Chang, Seattle, WA (US); Tina Lin Zeng, Pasadena, CA (US); John Oliver Por, San Francisco, CA (US); Tommy Chendong Li, Santa Monica, CA (US); Michael Blair Crouse, Seattle, WA (US); Roman Arora Arora, San Jose, CA (US); Marlon Aundrae Facey, New York, NY (US); Riley Nicole Tatum, Costa Mesa, CA (US); Tibor Tillmann Josef Goldschwendt, Culver City, CA (US)

(21) Appl. No.: 18/605,743

(22) Filed: Mar. 14, 2024

Related U.S. Application Data
(60) Provisional application No. 63/490,132, filed on Mar. 14, 2023.

(51) Int. Cl. G06F 16/9538; G06F 16/2457; G06F 16/9535; G06F 16/955

(52) U.S. Cl. CPC G06F 16/9538; G06F 16/24578; G06F 16/9535; G06F 16/9562

(57) ABSTRACT

A method may receive a request to open a starting interface within a browser. A cluster may be identified that includes a plurality of webpages from a browser history by: determining that the cluster includes a query and determining that a webpage of the plurality of webpages is associated with a first page access time that is within a time threshold. In response to identifying the cluster, a related search suggestion for a cluster topic may be obtained for the cluster. The user interface may include: a first region selectable to navigate to a first webpage of the plurality of webpages and a second region selectable to navigate to a second webpage of the plurality of webpages. The user interface may be displayed in the starting interface.

### CROSS-REFERENCE TO RELATED APPLICATION

This application claims priority to U.S. Provisional Patent Application No. 63/490,132, filed on Mar. 14, 2023, the disclosure of which is incorporated by reference herein in its entirety.

### BACKGROUND

Users trying to accomplish complex tasks that involve a lot of research and searching on the Internet can become overwhelmed by the sheer amount of information to review to identify and make sense of relevant content. Sometimes a project, for example planning a vacation, building a custom home, or filing taxes, spans multiple browsing sessions, often across multiple days, and across multiple devices.

### SUMMARY

The disclosure describes a method that selects a cluster representing previous browsing history relating to a particular topic (i.e., category) to populate a user interface element in response to opening a starting interface. A starting interface may be a browser window, for example a new tab page. A starting interface may be a welcome interface, which may be displayed in a side panel of a browser, or in a window of a browser-based operating system. A new tab page loads a webpage generated by the local browser application itself instead of loading a webpage from the open web. A welcome interface may surface post-login, including after a startup, a restart, coming out of a sleep mode, etc. A side panel can be opened at the request of a user (e.g., via a menu option, a predefined gesture or hot-key, etc.) The user interface element is configured to reduce user input to resume a particular previous research project. In examples, the browser may be a native browser application or a browser-based operating system. The user interface element, sometimes referred to as a card, may display a representation of a website or websites found in the browser history. The website or websites may relate to a cluster category. The user interface element may include suggestions for further searches related to the cluster category. The website or websites may be related to a query or queries. In some implementations, the clusters of web pages in the browser history may be formed based on similarity of content. In this way, a user is greeted with information in a starting interface that is relevant to the user. The elements of the user interface are configured to enable a user to seamlessly jump right back into a previous complicated work task without having to search for relevant information or take additional steps. The disclosure further describes a method to rank information from a browser history for display in the user interface based on attributes of data in the browser history.

### BRIEF DESCRIPTION OF THE DRAWINGS

FIG. 1A depicts a browser application with an example starting interface, according to examples described throughout this disclosure.

FIG. 1B depicts a browser application with an example starting interface, according to examples described throughout this disclosure.

FIG. 1C depicts an example user interface, according to examples described throughout this disclosure.

FIG. 1D depicts an example user interface, according to examples described throughout this disclosure.

FIG. 1E depicts an example user interface, according to examples described throughout this disclosure.

FIG. 2 depicts a system, according to examples described throughout this disclosure.

FIG. 3 depicts a flow diagram, according to examples described throughout this disclosure.

FIG. 4A depicts a flow diagram, according to examples described throughout this disclosure.

FIG. 4B depicts a flow diagram, according to examples described throughout this disclosure.

### DETAILED DESCRIPTION

The present disclosure describes a user interface element included in a new browser tab that reduces user input for jumping back into or continuing forward with a previous research project based on information derived and filtered from a user's browser history. Research projects often begin with a query, the user navigating to various webpages represented in search results generated for the query, navigating to other content based on links in the search result webpages, etc. Because of the complex navigation history, when a user puts down such a complicated project, it can be inefficient and frustrating to pick up the project where they left off again. Implementations provide a user interface element, based on browsing clusters, that provides various regions representing different ways to resume the research project. Implementations further describe a way to rank information from a browser history to present to a user.

Further to the descriptions below, a user may be provided with controls allowing the user to make an election as to both if and when systems, programs, or features described herein may enable collection of a user's browser history information, use the browser history information to generate webpage embeddings and/or clusters, and analyze, filter, and rank the clusters. Thus, the user may have control over what information is collected about the user, how that information is used, and what information is provided to the user.

A technical problem is related to how to filter, rank, and predict, based on a user's browser history, the most relevant information that a user can use to quickly resume a research task that spans multiple browser sessions. In examples, a browser session may be a period of time when a browser is being used by a user without pausing for a predetermined duration (for example not pausing for longer than one hour, or any other length of time). Users trying to accomplish complex tasks sometimes find it very difficult to stop and restart research online. If a browser application or any subset of browser tabs are closed during the project, the burden of finding information that was previously displayed makes it hard to seamlessly continue the task again. When an effort to accomplish a complex task spans multiple browser sessions, often across multiple days, and/or devices, it can be disorienting for the user. Moreover, a user may perform several different research projects or browsing activities over time and, therefore, have many different clusters associated with the user's browsing history. What is needed is a way to seamlessly access the information most relevant to a project.

While it is possible for the user to continue with a research task started in a previous browser session by recreating searches to find relevant websites again or opening a browser history to find a website previously visited, both actions require multiple steps and force the user to scan through large amounts of information to find where they left off. Many users open a starting interface (e.g., a new tab) within a browser when pivoting tasks. Many users do not set their homepage setting to a URL and therefore encounter content generated by the local browser application itself instead of loading a webpage from the open web. Such content generated for a new tab is referred to as a new tab page and is an example of a starting interface. Another example of a starting interface can be a user interface, e.g., window or card, presented to a user by a browser or browser-based operating system after a resumption trigger. A resumption trigger is an operating system event related to or indicative of a break in continuous device usage. Non-limiting examples of a resumption trigger include a start or restart operation, a wake from sleep operation, etc. In some implementations, a starting interface may be a user interface in a side panel of a browser window. A starting interface can be any interface generated by the browser (including a browser-based operating system) after an event indicative of a break in device usage and/or a task pivot.

One technical solution disclosed in the present Application is to add a user interface element to this starting interface, which enables a user to resume a research project with minimal user input. Because a user's history may include many different clusters (relating to many different categories or topics), a technical solution applies a filter or set of filters to a plurality of clusters in a browser history to identify a cluster or clusters determined to be most relevant to the user. A filter may include determining that a cluster is associated with at least one webpage previously accessed within a recent time threshold. A filter may include determining that the cluster is related to (e.g., the browsing history originated from) a user query. A cluster may have a topic (i.e., category) that the members of the cluster are directed to. In examples, a cluster topic may connect one or more topics (i.e., categories) of the members of the cluster. For example, if a cluster includes URLs that describe color palettes, room layouts and how to pick the best window covering for a room, the cluster topic may be ‘living room redecoration.’ A filter may include determining that a cluster topic represents a complex task, i.e., that the topic is in a category representing complex tasks. Such a category may include educational research, shopping, travel, etc. Clusters that satisfy the filter(s) may be ranked against each other. For example, a first cluster with a most recent access time may be ranked ahead of a second cluster with a later access time. Once a cluster (or two, three, etc.) have been identified for display (e.g., via the filter(s)), disclosed implementations determine which of the websites represented by the cluster to include in a user interface element (card) shown on the starting interface. Ranking factors may include recency of access, number of times accessed within the cluster, whether a website is bookmarked, has annotations, etc. In some implementations, ranking may be done by a machine-learned model.

Another technical solution includes identifying one or more clusters from a browser history and ranking those clusters based on a ranking signal that is based on one or more attributes of members of the cluster. The attributes captured by the ranking signal may capture patterns of user interactions with members of the cluster or characteristics of the members of the cluster themselves, for example. A cluster relevance rating (i.e., a ranking score) may be assigned to each cluster and used to select one or more clusters to include in the user interface. A cluster relevance threshold value may be used to filter out clusters that are unlikely to be relevant to a user.

Finally, implementations provide an informational user interface on the starting interface that provides selectable regions for accessing a top ranked website (or websites) from the identified cluster. The user interface may also include a selectable region with search suggestions related to the original query. The user interface may include an indication that the website is associated with a list of items (e.g., a shopping cart, bookmarks, annotations, etc.). In this way, a user is provided with access to the information that is most likely to be helpful to continue a previous research project. This may allow the user to seamlessly continue their project after opening a starting interface.

More specifically, the disclosure describes a method that provides easy access to select information relating to a cluster. For example, the methods described herein may be used when a “blank” starting interface is opened (for example, a new tab that loads a webpage generated by the local browser application itself instead of loading a webpage from the open web; thus, a new tab opened is “blank”, or lacks an association with a URL).

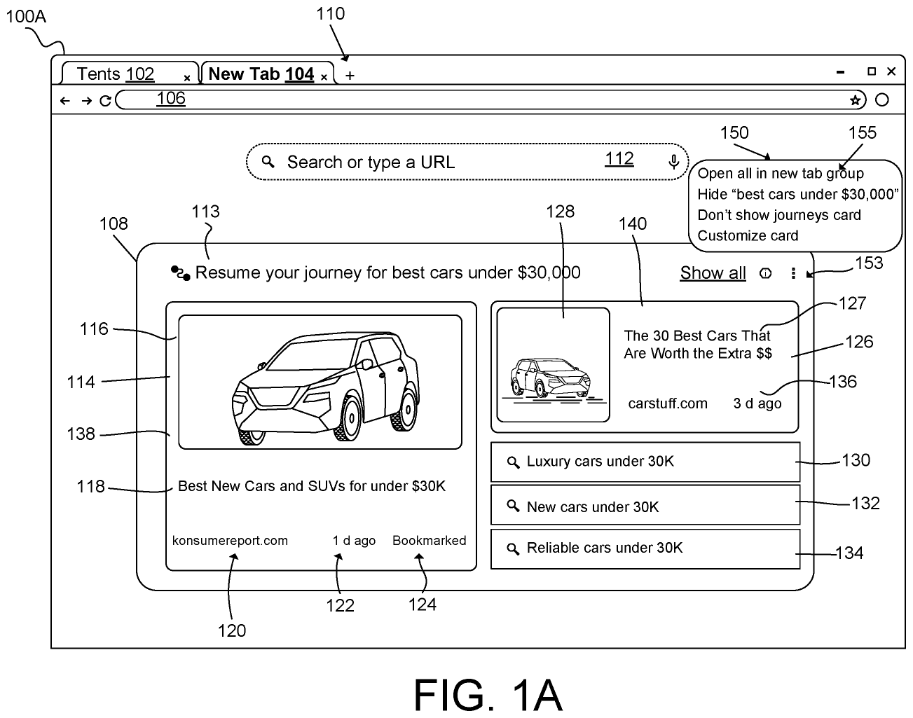

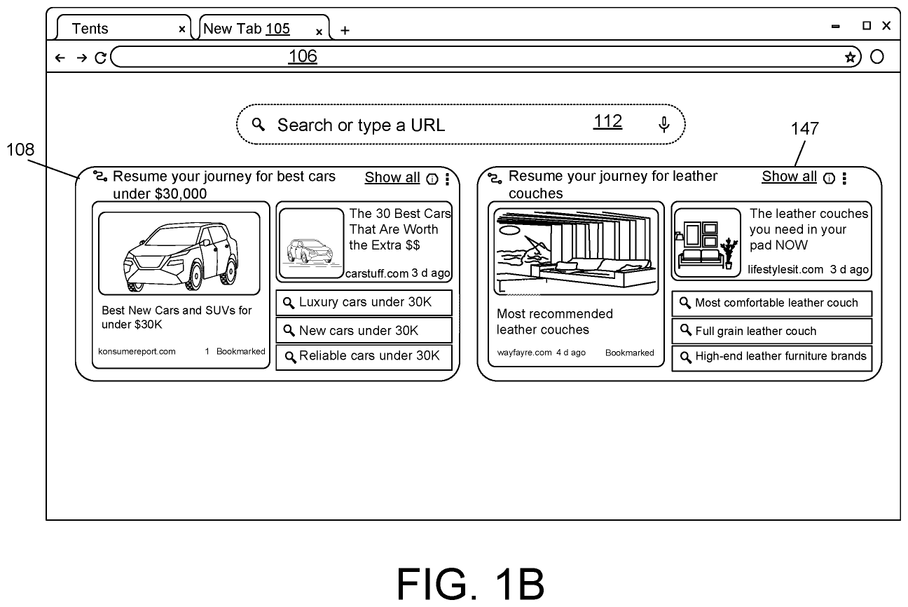

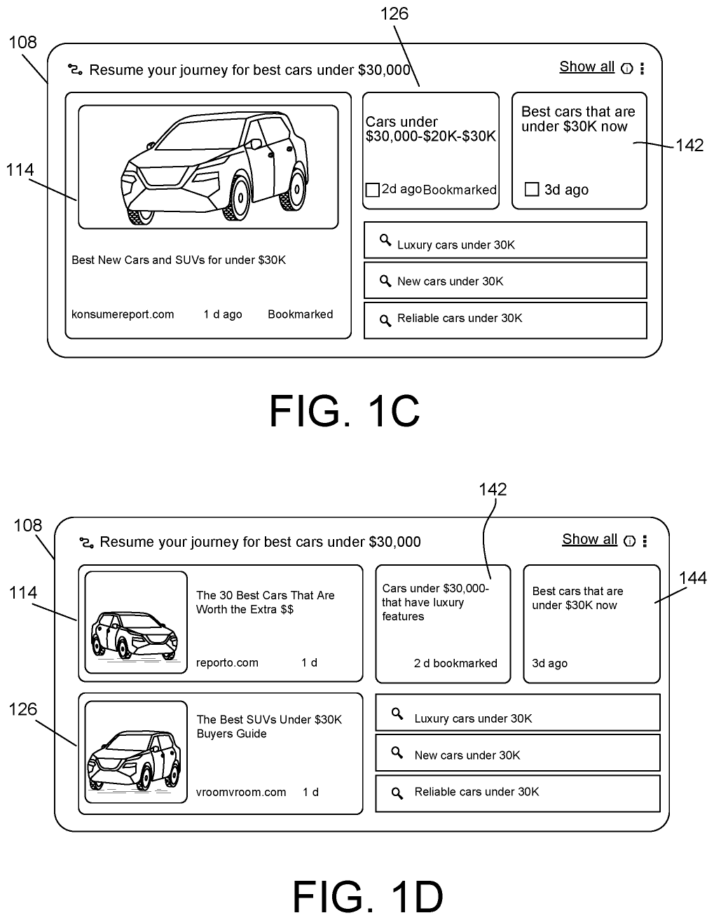

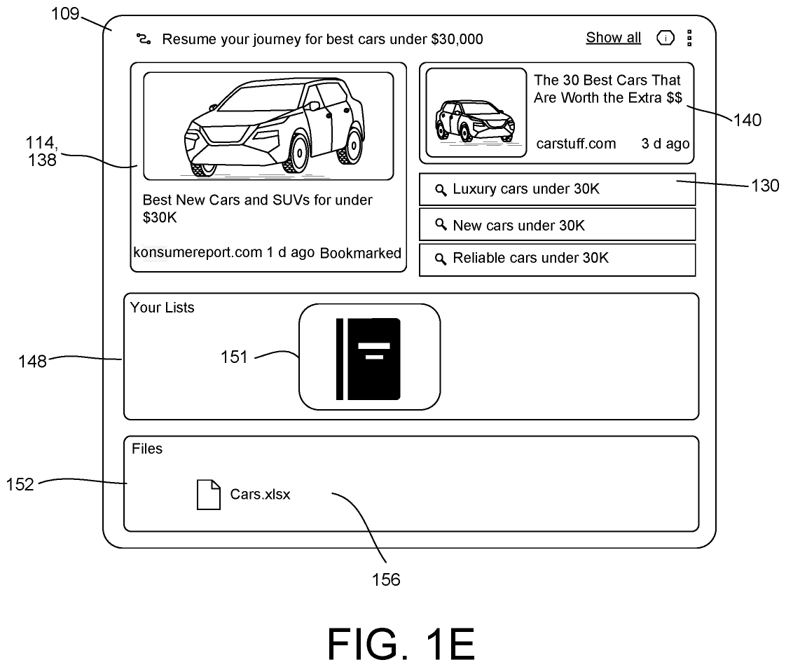

FIG. 1A depicts a browser application 100A, according to an example. Browser application 100A includes a starting interface 104, which may be used to display, search, or otherwise access information available on the Internet. In the example, starting interface 104 is a browser tab. This is not intended to be limiting, however. In examples, starting interface 104 may include a welcome interface of a browser or a browser-based operating system or a side panel of a browser, etc.

Browser application 100A includes a first tab 102 and starting interface 104, which is selected. First tab 102 points to a URL relating to the example tab title, “Tents.” Starting interface 104, however, is not pointing at any URL or webpage, and has a title reading, “New Tab.” In examples, starting interface 104 may have been opened when a user clicked on an open new tab button 110. In the example of FIG. 1A, open new tab button 110 is depicted with a plus sign symbol and positioned to the right of the rightmost positioned tab in browser application 100A. However, open new tab button 110 may be positioned anywhere in browser application 100A. Similarly, a command to open a new tab may be included in a menu. After selecting open new tab button 110, starting interface 104 opens to the right of the rightmost previous tab, which was first tab 102 in the example.

Open new tab button 110 opens starting interface 104 that does not point to any URL, as evidenced by blank URL bar 106. Starting interface 104 may include a search bar 112. In further examples, however, starting interface 104 may not include search bar 112.

Starting interface 104 includes a first user interface 108. First user interface 108 is an area defined by a boundary that includes data relating to a cluster from a user's browsing history. A browsing history may include information relating to one or more websites recently visited by a user. For example, a browsing history may include any combination of: search history data, downloaded history data, cookies, cached data, metadata (for example metadata relating to the content of a webpage visited, ex: title, keywords, when a website was last accessed, whether the website was the result of a user query, etc.), entities, images, files downloaded, and any related search suggestion activity associated with the web browser. A browsing history may include information about a browser interaction or navigation capturing how a user arrived at a webpage (for example via click, search, or a direct navigation) or departed from a webpage (for example, by clicking a link, performing a search, directly navigating to a webpage, or closing a tab). In examples, the browsing history may include additional data.

A cluster may represent a complicated research task or other work performed by a user via one or more search and/or browsing activities determined to be associated with a single cluster category over time. A cluster represents a previous work effort that the user may wish to continue in the future. A cluster includes members, which may include any combination of URLs or queries from a browser history. A cluster may be associated with one or more categories or topics. In examples, URLs included in a cluster may be associated with one or more categories or topics as well.

In examples, clusters may be associated with one or more categories. For example, clusters may include one or more webpages (e.g., identified by their URLs) that are associated with one or more common (shared) categories. In examples, clusters may be associated with a query and URLs that were selected by a user in response to a query. In examples, clusters may be associated with a time of query and include URLs visited after the query for a predetermined amount of time.

In examples, clusters may represent webpages with similar embeddings. The embeddings may be similar to (related to) a query embedding. As an example, the browser may, with user permission, generate a numerical representation that approximates the content of the webpage. The browser may provide content represented in the resource to a large language model, which generates the embedding for the webpage. A large language model may be used to generate the embeddings because such a model can efficiently capture semantic relationships, thus minimizing the memory resources utilized to provide the ability to recall previously visited resources based on the content of the resource.

The large language model may be tuned for generating embeddings for webpages. For example, the model may be provided with a training set of resources representing web pages. In some implementations, a pre-processing step may break the content of the resource into passages. An embedding may be generated for each passage. Thus, the number of embeddings stored for a webpage by the browser can depend on the number of passages identified for the content of a previously visited webpage. In some implementations, the model may be tuned on passage size. In some implementations, the model may be tuned on the number of passages stored (number of embeddings generated) per resource. The embeddings can be used to determine similarity with a query or with another webpage.

In examples, clusters may be identified from a browser history or other section of memory. In examples, clusters may be generated dynamically based on the browser history.

First user interface 108 generated by methods described herein offers numerous pathways for a user to restart the task related to the cluster topic again. As may be seen in FIG. 1A, a title 113 of first user interface 108 reads, “Resume your journey for best cars under $30,000.” The cluster category, for example first user interface 108 is “best cars under $30,000”, and first user interface 108 includes a plurality of webpages relating to that cluster category.

A first webpage 114 and a second webpage 126 may be displayed in first user interface 108. In examples first webpage 114 and second webpage 126 were previously accessed by a user in response to one or more search queries. In examples, any combination of first webpage 114 and second webpage 126 may have been accessed at an access time that is within a time threshold.

First webpage 114 may be displayed on a first region 138 with a first webpage title 118 and a first image 116. In examples, second webpage 126 may be displayed in a second region 140 with a second webpage title 127. First region 138 is selectable to navigate to the first webpage URL and second region 140 is selectable to navigate to the second webpage URL, respectively.

In examples, first user interface 108 may further include any number of related search suggestions that are associated with the cluster category. Example related search suggestions to cluster category “best cars under $30,000” may include, for example, “Luxury cars under 30K”, “New cars under 30k”, and “Reliable cars under 30K”. In examples, first user interface 108 may further include a third region 130, which may be selectable to initiate a new query of a first related search suggestion. In examples, first user interface 108 may further include any combination of additional regions selectable to initiate a new query of additional related search suggestions. For example, an additional region 132 may be selectable to initiate a query for a second related search suggestion and an additional region 134 may be selectable to initiate a query for a third related search. In examples, the one or more related search suggestions may be received by querying a server using the cluster category as input.

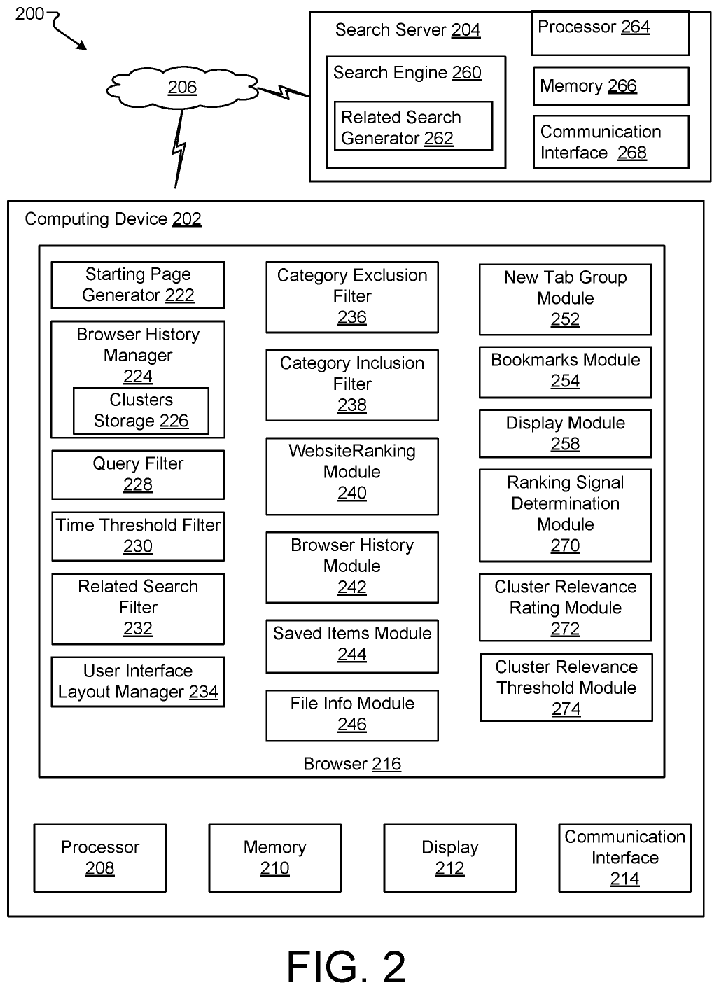

FIG. 2 depicts system 200 in accordance with an example. System 200 may be used to generate starting interface 104 including information relating to a cluster. System 200 includes a computing device 202, a search server 204, and Internet 206.

Computing device 202 may be used to browse content on the Internet via one or more browser tabs within a browser application. Computing device 202 includes processor 208, memory 210, display 212, and communication interface 214.

In examples, processor 208 may include multiple processors, and memory 210 may include multiple memories. Processor 208 may be configured by instructions to generate the starting interface described in the disclosure. The instructions may include non-transitory computer-readable instructions stored in, and recalled from, memory 210.

Display 212 may comprise any type of display internal or external to computing device 202.

Communication interface 214 of computing device 202 may be operable to facilitate communication between computing device 202 and search server 204 or another computing device. In examples, communication interface 214 may utilize short-range wireless communication protocols, such as BLUETOOTH, Wi-Fi, Zigbee™, or any other wireless or wired communication methods.

Memory 210 may include code to operate browser 216. In examples, browser 216 may comprise a web browser. Memory 210 may further include one or more software modules operable to generate a starting interface including one or more user interfaces with cluster or other information.

Browser 216 includes starting interface generator 222, browser history manager 224, query filter 228, time threshold filter 230, related search filter 232, user interface layout manager 234, and display module 258. In examples, computing device 202 may further include category exclusion filter 236, category inclusion filter 238, website ranking module 240, browser history module 242, saved items module 244, file info module 246, new tab group module 252, and bookmarks module 254.

Starting interface generator 222 may receive a request to open a starting interface within a browser, the starting interface displaying an interface that is generated by the browser. In examples, starting interface generator 222 may receive a request after a user initiates the opening of starting interface 104, for example by selecting open new tab button 110. In examples, starting interface generator 222 may determine what information will be rendered with starting interface 104 and initiate the rendering and display of that information.

Browser 216 includes browser history manager 224 may save a browser history, generate cluster storage 226 from that browser history, and provide access to cluster storage 226. Cluster storage 226 includes one or more clusters, each cluster including a cluster category and a plurality of webpages from a browser history related to the cluster category. The browser history may be used to generate clusters that represent a previous search journey for the user.

Browser history manager 224 may include one or more settings that allow the user to determine what kind of cluster category it saves in cluster storage 226. In examples, browser history manager 224 may allow a user to disable adding information to cluster storage 226 or to delete cluster storage 226 entirely. Browser history manager 224 may include settings that allow a user to keep information relating to cluster storage 226 locally on memory 210 instead of storing it on search server 204. In examples, browser history manager 224 may allow a user to exclude certain cluster categories from being saved and managed in cluster storage 226. Facilitating deletion of precise portions of browser history and clusters may respect user privacy and security, particularly in instances where other users may have access to the same computing system.

Cluster storage 226 may be filtered and ranked to select the cluster most likely to be associated with a project that the user may want to continue in a future browser session. A first cluster may be associated with first user interface 108 on starting interface 104, providing a streamlined way for a user to continue a previous research effort. First user interface 108 may be used to quickly access websites and search suggestions related to the cluster category.

One or more filters are executed to identify the first cluster from cluster storage 226. The filters may be used to determine which clusters in cluster storage 226 include any combination of the following features: webpages that were accessed via a query search, webpages that were accessed within a time threshold, a cluster category that is not part of a category exclusion list, cluster topics in a category that is part of a category inclusion list, and clusters with websites that include images, as will be further described below.

Query filter 228 may determine that the plurality of webpages of the first cluster were accessed in response to a user query, or a search query. A user query is an entry into a search engine that yields results including websites or information related to the results. For example, a user query may be initiated by performing a search via a search engine. By providing query filter 228, it may be possible to identify a cluster for display on first user interface 108 that was the topic of a previous search effort. A cluster that was the topic of a previous search may be more relevant to a user, who may be looking to continue the search.

In FIG. 1A, for example, it may be seen that first webpage 114 and second webpage 126 are related to a cluster category, “best cars under $30,000”, and point to URLs for car review websites.

Time threshold filter 230 may determine that the first webpage is associated with a first page access time that is within a time threshold. The first page access time may be a time and date that the first webpage was last accessed (i.e., displayed on a user device) by the user. The time threshold may be a threshold of time within the present time, for example 4 days or 3 months, within which a first webpage access may be recent enough to be considered to be of relevance to a user.

In examples, time threshold filter 230 may further determine that the second webpage is associated with a second page access time that is within the time threshold.

For example, as may be seen in FIG. 1A, first webpage 114 includes a last time visited indication 122 of “1 day ago” and second webpage 126 includes a last time visited indication 136 of 3 days ago.

In response to identifying a cluster from cluster storage 226 using query filter 228 and time threshold filter 230, browser 216 may execute related search filter 232 and user interface layout manager 234.

Related search filter 232 may obtain a related search suggestion to the cluster category. A related search suggestion includes keywords for a query related to the cluster category and may be generated based on a search engine algorithm. In examples, the related search suggestion may be determined by querying search server 204, as will be further described below. In examples, one or more related search suggestions may be ranked and displayed in order of ranking.

For example, in FIG. 1A, it may be seen that first related search associated with third region 130, “Luxury cars under 30K”, the second related search associated with additional region 132, “New cars under 30K”, and third related search associated with the additional region 134 have all been determined to be related to cluster category, “best cars under $30,000”. In examples, third region 130, additional region 132, and additional region 134 may be displayed from top to bottom in order of rank.

User interface layout manager 234 may generate first user interface 108 for the first cluster. First user interface 108 is a continuous region of starting interface 104 dedicated to the display information related to the cluster or the cluster category.

First user interface 108 may include a first region displaying a first webpage title and a first image from the first webpage of the plurality of webpages. The first region is a section of first user interface 108 dedicated to information around the first webpage, selectable to navigate to a first webpage address.

For example, returning to FIG. 1A, it may be seen that first region 138 includes a first webpage title 118, “Best New Cars and SUVs for under $30K can run onto two lines”, and first image 116. If the user clicks on anything within first region 138, the user will be taken to the URL related to the first website.

First user interface 108 may further include a second region displaying a second webpage title from the second webpage, the second region being selectable to navigate to a second page address. Second region 140 is a section of first user interface 108 dedicated to information around the second webpage of the plurality of webpages, second region 140 being selectable to navigate to the second webpage address.

In FIG. 1A it may be seen that second region 140 includes a second webpage title 127, “The 30 best cars that are worth the Extra $$”. In examples, second region 140 may further include second image 128. If the user clicks on anything within second region 140, the user will be taken to the URL related to the second website.

In examples, first region 138 may further include a URL label 120. In examples, URL label 120 may provide the domain name. In examples, URL label 120 may provide a full path.

First user interface 108 may further include a third region displaying a related search suggestion, the third region being selectable to initiate the related search suggestion as a new query. For example, in FIG. 1A it may be seen that a third region 130 includes a title, “Luxury cars under 30K”. Clicking on third region 130 will initiate this related search in a new query via an online search engine. In examples, selecting third region 130 may open the search in an additional browser tab, or in starting interface 104.

In examples, user interface layout manager 234 may generate a first region with a first size based on a first property of a first image and generate a second region with a second size based on a second property of second image. In examples, the first property and the second property may be the file sizes or resolutions of the first and second images, respectively. In examples, the first property and the second property may relate to the content of the first and second images, such as the angle or size of an object of interest in the photo. In examples, the first property and the second property may relate to position of the photo on the webpage, e.g., where an image closer to the top of the webpage may be favored over images further down the webpage content. In examples, the first property and the second property may relate to the position of the photo in the page structure (e.g., a DOM tree). In examples, the first property and the second property may relate to dimensions of the image, e.g., where an image with larger dimensions is favored over images with smaller dimensions. In examples, image properties may be compared to user interface inclusion criteria. The user interface inclusion criteria may describe a minimum property value (or minimum property values) for an image to be eligible for inclusion in a user interface. In examples, the user interface inclusion criteria may be represented in a model (e.g., a machine-learned classifier). In such examples, the model may be configured to use a property or multiple properties of an image to determine if a particular image meets the user interface inclusion criteria. In examples, the model may take all images of a webpage as input and identify, as the model output, a preferred image for display in the user interface. In examples, the user interface inclusion criteria can be used as a filter. For example, a webpage that includes an image with properties meeting the user interface inclusion criteria may be ranked ahead of a webpage that does not include an image with properties meeting the user interface inclusion criteria. As another example, a cluster that does not include a webpage having an image with properties that meet the user interface inclusion criteria may not be selected for a user interface.

The dimensions of the image in the user interface may be based on several factors. For example, as may be seen in FIG. 1A, first image 116 may have a first size (dimension) that is larger than a second size (dimension) of second image 128 because first image 116 is included in the first webpage, because the first image 116 has a higher relevance score with respect to the first webpage than the second image 128 has with respect to the second webpage, because the first image 116 may be a larger file than second image 128, etc.

In examples, user interface layout manager 234 may generate the first region with a first size and the second region with a second size, the first size and the second size being based on a quantity of other portions included in the starting interface. In examples, the quantity of other portions may change, for example, based on a number of websites associated with a cluster that are selected for display in first user interface 108 based on one or more filters. In examples, the quantity of other portions may change, for example, based on the number of related searches associated with the cluster.

In other examples, however, user interface layout manager 234 may have one or more predetermined templates that may be selected based on the number of websites and the number of related searches associated with a cluster that are selected for display.

For example, FIGS. 1C and 1D depict alternative examples of first user interface 108. The example of FIG. 1C includes first webpage 114, second webpage 126, and a third webpage 142, while the example of FIG. 1D includes first webpage 114, second webpage 126, third webpage 142, and a fourth webpage 144. Because FIG. 1C includes three webpages to display, second webpage 126 is made smaller so that second webpage 126 and third webpage 142 may fit in the same space used for second webpage 126 in FIG. 1A. Because FIG. 1D includes four webpages to display, first webpage 114 is made smaller so that first webpage 114 and second webpage 126 can fit in the same space used by first webpage 114 in FIG. 1A. Similarly, in FIG. 1D third webpage 142 and fourth webpage 144 share the space used by second webpage 126 in FIG. 1A.

In examples, one or more additional user interfaces relating to one or more additional clusters may be generated. A second cluster may be identified, by browser history manager 224 by accessing cluster storage 226. In examples, the second cluster may be filtered using any combination of query filter 228, time threshold filter 230, related search filter 232, category exclusion filter 236, and category inclusion filter 238, as described above with regards to the first cluster.

In response to identifying the second cluster, a second user interface may be generated for the second cluster. The second user interface may include similar features to first user interface 108. For example, the second user interface may be generated using user interface layout manager 234, website ranking module 240, browser history module 242, and bookmarks module 254, or any other module described herein in reference to the first cluster.

For example, FIG. 1B depicts a new tab 105, according to an example. In the example the second cluster category is “leather couches”. A second user interface 147 is included in new tab 105 related to the second cluster, which may include any combination of related websites and related search suggestions. As may be seen, second user interface 147 includes regions dedicated to two webpages providing reviews of leather couches. Second user interface 147 also includes three additional regions that are each dedicated to a related search suggestion to the cluster category, “leather couches”.

In examples, browser 216 may further execute category exclusion filter 236. Category exclusion filter 236 may determine if a cluster category is associated with a category that is not on a category exclusion list. If a cluster category is not associated with a category on the category exclusion list, the related cluster may be selected for display in a starting interface. In examples, category exclusion filter 236 may prevent the display of a cluster related to a sensitive cluster category that a user may not want to see when opening starting interface 104 because, for example, the user may only want to work on that cluster category when they are alone or at specific times. For example, the category exclusion list may include categories such as pregnancy, religion, or mental illnesses. In examples, category exclusion filter 236 may offer one or more settings allowing a user to personalize the category exclusion list.

In examples, browser 216 may further execute category inclusion filter 238. Category inclusion filter 238 may determine that the cluster category is associated with a category that is included in a category inclusion list before displaying it in a starting interface. In examples, category inclusion filter 238 may help flag categories that the user would find especially helpful to be offered an opportunity to jump back into. Inclusion categories may be very complex tasks, require multiple sessions of searching, or be time sensitive tasks that need completing, for example. Inclusion categories may include categories such as heating, ventilation and air conditioning systems, tax issues, or mud room plans. In examples, category inclusion filter 238 may offer one or more settings allowing a user to personalize the category inclusion list.

In examples, browser 216 may execute website ranking module 240. In examples, the first webpage may be associated with a higher ranking than a ranking of the second webpage. The first webpage ranking and the second webpage ranking may be generated based on any combination of criteria, including but not limited to: a number of user visits to a website, how recently a website was accessed, the popularity of a website, a property of an image displayed with a website (such as the size or resolution of the image), and the content of the website. Website ranking module 240 may provide rankings for a cluster based on the first ranking and the second ranking. In examples, website ranking module 240 may provide rankings for each website included in a cluster based on other criteria not related to the first and second ranking as well.

In examples, website ranking module 240 may cause the display of the first region related to the first website and the second region related to the second website in an order within the first user interface based on the first ranking and the second ranking. For example, first region 138 and second region 140 may be displayed within first user interface 108 based on their respective popularities.

In examples, browser 216 may execute browser history module 242. Browser history module 242 may determine that the cluster category is one that a user has searched across two or more browsing sessions by referencing websites and metadata saved in the browser history or cluster storage 226. For example, browser history module 242 may determine that one or more websites associated with a cluster were each accessed on different days. By identifying clusters associated with multiple browser sessions for display in first user interface 108, browser history module 242 may identify cluster categories that are complicated and/or that the user is more likely to come back to.

In examples, browser 216 may execute saved items module 244. Saved items module 244 may generate a fourth region that provides a way to access a list of saved items. In examples, the list of saved items may be associated with the first website or the second website on a card. In examples, a list of saved items may include a shopping cart, a productivity list, a list of recipes, a grocery list, or any other type of list.

In examples, the list of saved items may be associated with the first cluster associated with first user interface 108. In further examples, however, the list of saved items may be unrelated to a cluster. In examples, the list of saved items may be associated with a cluster associated with a user interface. In examples, the list of saved items may be related to one of the first webpage or the second webpage. In examples, the association of the list of saved items with one of the first webpage or the second webpage may influence the ranking of that webpage.

FIG. 1E depicts user interface 109, according to an example. User interface 109 may be similar to first user interface 108 in that it may include first region 138, second region 140, and third region 130. User interface 109 further includes a fourth region 148 including a list of saved items 151, however. Fourth region 148 may include a title, for example “Your Lists”. In examples, list of saved items 151 may be selectable to navigate to a URL or memory 210 to display the list of saved items. In examples, list of saved items 151 may be selectable to navigate to a page generated by browser 216 that displays list of saved items 151. In further examples, fourth region 148 may include additional lists of saved items.

In the example of FIG. 1E, list of saved items 151 is a list of annotations. List of saved items 151 may comprise annotations that a user attached to the first webpage 114 associated with first region 138. For example, a user may have generated annotations for the cars rated on first webpage 114.

In examples, browser 216 may further execute file info module 246. File info module 246 may identify a file accessed at a location saved in a browser history. In examples, the file may be saved on a cloud server. In examples, the file may be saved on memory 210 of computing device 202. In examples, the file may be related to the cluster or the plurality of websites displayed on a user interface within a starting interface.

File info module 246 may generate a fifth region displaying a file title, the fifth region being selectable to initiate opening the file. For example, a fifth region 152 is depicted in FIG. 1E. Fifth region 152 includes an example title, “Files” and a file title 156, “Cars.xlsx”.

In examples, fifth region 152 may include further file information. For example, fifth region 152 may include information about when the file was last accessed, how large it is, the file type, the URL where the file is saved on the cloud, or any other type of file information. In examples, file info module 246 may apply one or more filters to determine which files are displayed in fifth region 152. For example, file info module 246 may display a file upon determining it was accessed at a file access time that is within the time threshold.

In examples, browser 216 may execute new tab group module 252. New tab group module 252 may display a control (for example, a button or a menu item) to open a new tab group in browser 216. The new tab group may include a second tab for the first web address and a third tab for the second web address. For example, FIG. 1A depicts a menu 150, which can be accessed by clicking menu icon 153. Menu 150 includes a control 155, a menu item titled, “Open all in new tab group”. Upon selecting control 155, new tab group module 252 may open the first webpage in a second tab and open the second webpage in the third tab.

In examples, browser 216 may execute bookmarks module 254. Bookmarks module 254 may generate an indication within the first user interface of whether the first webpage is bookmarked in a browser. For example, bookmarks module 254 may compare a URL associated with first webpage 114 to a bookmark file maintained by browser 216, i.e., a collection of bookmarks. Upon finding a bookmark associated with the URL, bookmarks module 254 may include a marker on first webpage 114 to represent that the first website is bookmarked.

For example, as may be seen in FIG. 1A, a marker 124 indicates, “Bookmarked”.

In examples, the bookmarks module 254 may also be configured to look for annotations associated with the first webpage, e.g., in a collection of annotations. Annotations represent additional information associated with an address (e.g., URL) of a webpage. The annotation may be attached to the address of the webpage via a tab group. For example, a webpage may be part of a tab group and an annotation may be associated with an identifier for the tab group. Any webpage that is part of the tab group is, by virtue of inclusion in the group, associated with such an annotation. Annotations may include notes. Notes can include text provided by a user. Notes can include images selected by a user. The annotations may be stored in a file maintained by browser 216. The annotations can include future actions. The future actions can be, for example, a price tracking action, a read later action, a reminder action (e.g., content update reminder, time reminder, etc.).

Computing device 202 may further include display module 258. In examples, display module 258 may cause the display of one or more user interfaces in one or more starting interfaces. For example, display module 258 may cause the display of any combination of first user interface 108, second user interface 147, fourth region 148, and fifth region 152 in starting interface 104 or new tab 105, as described above. Display module 258 may display browser 216 via an internal or external display in communication with computing device 202.

In examples, computing device 202 may be used to identify a cluster for display. In examples, the cluster may include a plurality of webpages from a browser history. The cluster may be identified by determining a ranking signal (or signals) for the cluster and determining a cluster relevance rating based on the ranking signal/signals. Therefore, in examples browser 216 may include ranking signal determination module 270 and cluster relevance rating module 272.

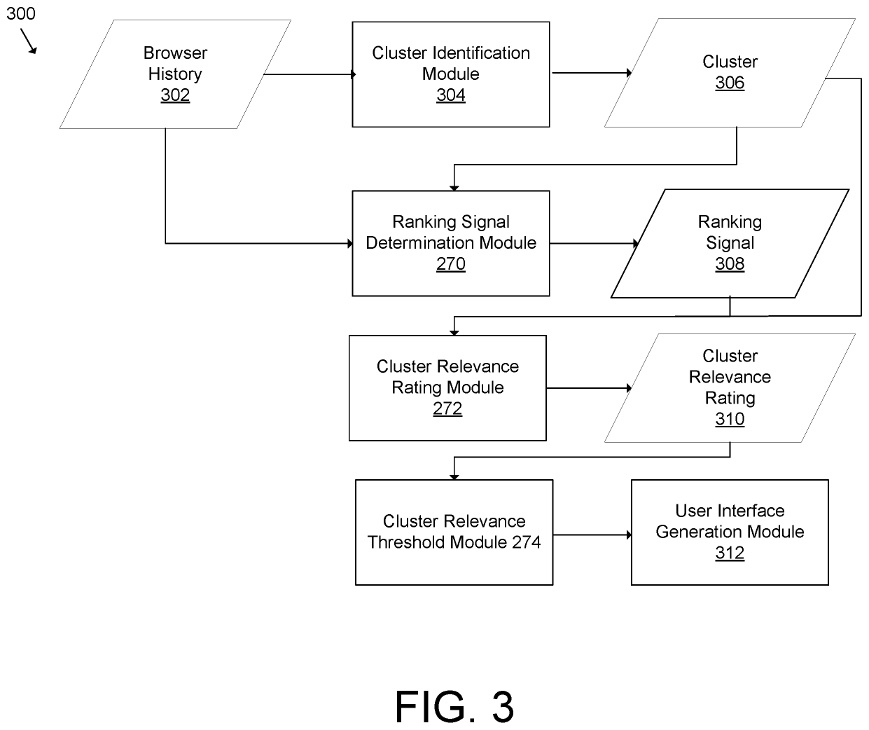

For example, FIG. 3 depicts a flow diagram 300. Flow diagram 300 begins with cluster identification module 304, which receives browser history 302 and determines one or more clusters 306. For example, cluster identification module 304 may identify clusters via any of the methods described above.

Ranking signal determination module 270 may determine a ranking signal 308 for the cluster 306 based on an attribute of the cluster 306 or upon an attribute of members of the cluster 306. The attribute may be metadata about interactions with websites in the cluster, metadata about interactions with the cluster, etc. . . . A ranking signal 308 is a signal that can be used as an input to rank (i.e., generate a ranking score for) a cluster 306. In examples, the attribute may capture a user pattern of behavior interacting with a cluster 306. In examples, the attribute may relate to and/or be shared by the members of the cluster 306. In examples, the attribute may be any quality, feature, or user interaction, relating to the members of the cluster 306. In examples, the attribute may reflect metadata (such as a topic) derived from or describing one or more members of the cluster 306. In non-limiting examples, ranking signal(s) that are based on the attribute(s may include one or more of:
a boolean attribute that reflects whether the currently engaged cluster belongs-to/is associated with the most frequently seen category in the last day/week for the given user;
a boolean attribute that reflects whether the currently engaged cluster belongs to the most frequently engaged category;
a number (count) reflecting the number of (count of) times the given cluster has been shown to the user during a most recent timeframe (e.g., in the last Dec. 24, 1948/etc. hours);
a number (count) reflecting the number of times the given cluster has had engagement during a most recent timeframe (e.g., in the last Dec. 24, 1948/etc. hours);
a number (count) reflecting the number of times the most frequent category (topic) for the cluster (e.g., the category shared by the most/highest number of members) has been seen by the user during a most recent timeframe (e.g., in the last Dec. 24, 1948/etc. hours);
a number (count) of times the most frequent category for the cluster has been engaged by the user during a most recent timeframe (e.g., in the last Dec. 24, 1948/etc. hours);
a number (count) of times a cluster has been seen by a user during a most recent timeframe (e.g., in the last Dec. 24, 1948/etc. hours);
a number (count) of times a cluster has been accessed by a user during a most recent timeframe (e.g., in the last Dec. 24, 1948/etc. hours);
a number of (count) of times a category has been seen by a user during a most recent timeframe (e.g., in the last Dec. 24, 1948/etc. hours); or
a number (count) of times a category has been accessed by a user during a most recent timeframe (e.g., in the last Dec. 24, 1948/etc. hours).

In examples, ranking signal determination module 270 may determine more than one ranking signal 308. In examples, ranking signal determination module 270 may access data in a browser history 302 to determine a ranking signal 308. In other examples, however, one or more ranking signals 308 may be determined dynamically. In examples, the attribute of the members of the cluster 306 may be based on a portion of the browser history 302 that falls within a time threshold (i.e., 24 hours).

Once ranking signal determination module 270 has determined one or more ranking signals 308, cluster relevance rating module 272 may use those ranking signals 308 as input into a cluster relevance rating module 272 to determine a cluster relevance rating 310. A cluster relevance rating 310 may be a probability or rating of how relevant a cluster 306 is likely to be to a user. In examples, the cluster relevance rating 310 may be a probability of how likely a user is to select a member of a cluster 306 if the user is presented with the option.

In examples, the cluster relevance rating module 272 may include any function that may receive one or more ranking signals as input and output a cluster relevance ranking. For example, the cluster relevance rating module 272 may include fuzzy logic. In examples, the cluster relevance rating module 272 may include a machine-learned model. The machine-learned model may be trained on data that includes a number of ranking signals determined from user browser histories, along with which clusters a user engaged with or didn't engage with when presented with a display of a cluster.

In examples, browser 216 may further include a cluster relevance threshold module 274. Cluster relevance threshold module 274 may determine whether the cluster relevance rating 310 is greater than a cluster relevance threshold value 312. The cluster relevance threshold value 312 may be predetermined to filter out clusters that are unlikely to be selected by a user. Only if cluster relevance threshold module 274 determines that the cluster relevance rating 310 is greater than a cluster relevance threshold value 312 may cluster 306 be displayed in a user interface. If no clusters 306 have cluster relevance ratings 310 that are greater than the cluster relevance threshold, then no clusters 306 may be displayed.

In response to identifying the cluster, a user interface may be generated for the cluster, as described above with respect to display module 258.

In examples, a cluster may be identified via ranking signal determination module 270 and cluster relevance rating module 272 upon receiving a request to open a starting interface within a browser. The starting interface may display of the user interface.

In examples, a related search suggestion may be obtained for a cluster topic for the cluster and displayed in the user interface. For example, a related search suggestion may be obtained via related search filter 232, as described above.

In examples, identifying the cluster may further include determining that a cluster category is not included in a category exclusion list. For example, category exclusion filter 236 may be executed, as described above.

In examples, determining the cluster relevance rating may further include increasing the cluster relevance rating upon determining that a cluster category is included in a category boost list. The category boost list may include categories that may be more likely to be relevant to a user than other categories. When a cluster includes a cluster category that is on the category boost list, it may be prioritized for display to a user by adding some value to the cluster relevance rating.

In examples, the cluster may include a login webpage that is not displayed in the user interface. A login webpage is a webpage that allows a user to log into an account online. In other words, login webpages may be purposefully excluded from display in user interfaces. This may help provide information-oriented webpages in the user interface for the user to engage.

In examples, the browser history may be shared between two or more devices. For example, the user may have an account with a browser across multiple devices, and, upon receiving permission from the user, the information from multiple devices may be saved in a joint browser history. For example, the joint browser history may be saved on one or both of the two devices.

In examples, system 200 may further include internet 206. Internet may be operable to allow for the delivery of packets and information between computing device 202 and search server 204 or any other servers. Internet 206 may allow computing device 202 to receive and display information from websites via one or more URLs.

In examples, the methods described herein to identify the first cluster and a related search suggestion and generate a first user interface may be performed within a second of the request to open the starting interface.

In examples, system 200 may further include search server 204. Search server 204 may include a search engine 260, a related search generator 262, a processor 264, memory 266, and communication interface 268. In examples, processor 264 may include similar features to processor 208, memory 266 may include similar features to memory 210, and communication interface 268 may include similar features to communication interface 214.

Search engine 260 may be operable to receive a user query from browser 216 executing on computing device 202, search a database for items related to the user query, and send URLs for related websites and/or other information related to the user query back to computing device 202. Search engine 260 may further include related search generator 262, which may provide one or more related searches to the cluster category, as described above.

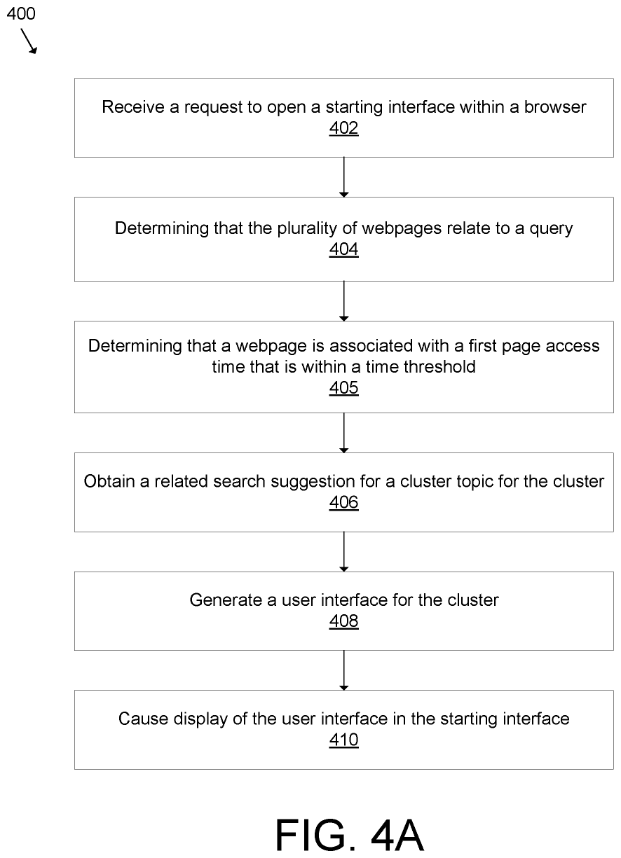

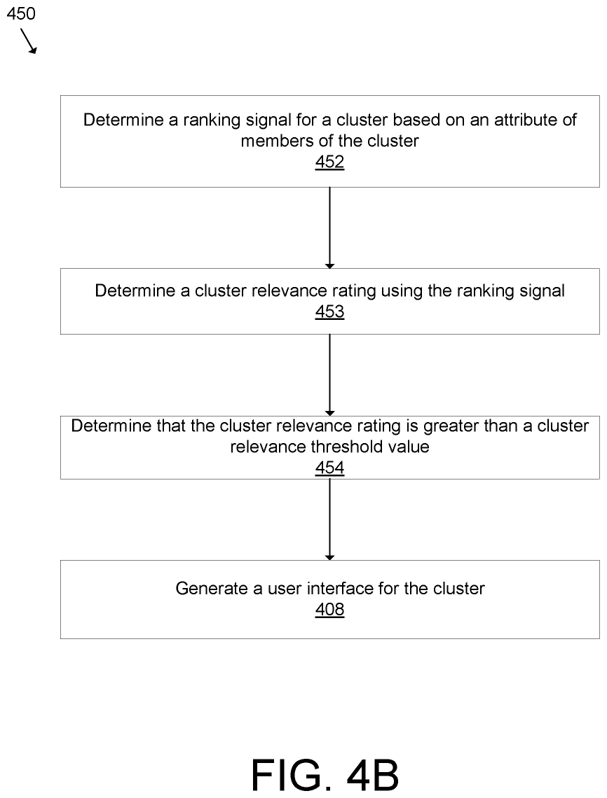

FIG. 4A depicts a flowchart of method 400, according to examples. Method 400 may be used to display a user interface in a starting interface including a cluster.

Method 400 begins with step 402. In step 402, a request may be received to open a starting interface within a browser. For example, starting interface generator 222 may be executed, as described above.

Method 400 continues with step 404. In step 404, a plurality of webpages may be determined that relate to a query. For example, query filter 228 and time threshold filter 230 may be executed, as described above.

Method 400 continues with step 405. In step 405, a webpage associated with a first page access time may be determined to be within a time threshold. For example, time threshold filter 230 may be executed, as described above.

Method 400 may continue with step 406. In step 406, a related search suggestion may be obtained for a cluster topic for the cluster.

Method 400 may continue with step 408. In step 408, a user interface may be generated for the cluster. For example, user interface layout manager 234 may be executed, as described above.

Method 400 may continue with step 410. In step 410, the user interface may be displayed in the starting interface. For example, display module 258 may be executed, as described above.

FIG. 4B depicts a flowchart of method 450, according to examples. Method 450 may include any of the steps described above with respect to method 400, in addition to steps 452. In step 452, a ranking signal may be determined based on an attribute of members of the cluster. For example, ranking signal determination module 270 may be executed, as described above.

In examples, method 450 may further include step 453. In step 453, a cluster relevance rating may be determined using the ranking signal. For example, cluster relevance rating module 272 may be executed, as described above.

In examples, method 450 may further include step 454. In step 454, it may be determined that the cluster relevance rating is greater than a cluster relevance threshold value. For example, cluster relevance threshold module 274 may be executed, as described above.

In examples, method 450 may include step 408. In step 408, a user interface may be generated for a cluster, as described above.

The methods disclosed herein provide a way to present seamless access to a prior search or project that a user may wish to continue when opening a starting interface. By filtering for a cluster associated with webpages that were previously discovered via a user query and accessed within a time threshold, it may be possible to identify a prior work task that a user is more likely to wish to continue. By providing a category exclusion list, it is possible to avoid a displaying of an embarrassing or sensitive research topic at the wrong moment. By providing a category inclusion list, it is possible to flag categories that are known to be more relevant to a user. By displaying clusters or websites within a cluster in order of their rankings, it is possible to place information that is more likely to be relevant to a user where they may encounter it first. By filtering for cluster categories that a user has searched across two or more browsing sessions, it may be possible to identify complicated topics that a user is more likely to need to return to or need help returning to.

Various implementations of the systems and techniques described here can be realized in digital electronic circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. Various implementations of the systems and techniques described here can be realized as and/or generally be referred to herein as a circuit, a module, a block, or a system that can combine software and hardware aspects. For example, a module may include the functions/acts/computer program instructions executing on a processor or some other programmable data processing apparatus.

Some of the above example implementations are described as processes or methods. Although operations may be described as sequential processes, many of the operations may be performed in parallel, concurrently or simultaneously. In addition, the order of operations may be re-arranged. The processes may be terminated when their operations are completed but may also have additional steps not included in the figure. The processes may correspond to methods, functions, procedures, subroutines, subprograms, etc.

Methods discussed above may be implemented by hardware, software, firmware, middleware, microcode, hardware description languages, or any combination thereof. When implemented in software, firmware, middleware or microcode, the program code or code segments to perform the disclosed tasks may be stored in a machine or computer-readable medium such as a storage medium. A processor(s) may perform the disclosed tasks.

Specific structural and functional details disclosed herein are merely representative for purposes of describing example implementations. Example implementations, however, have many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

The terminology used herein is for the purpose of describing particular implementations only and is not intended to be limiting of example implementations. As used herein, the singular forms a, an, and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

In some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), Graphics Processing Units (GPUs), digital signal processors (DSPs), application-specific-integrated-circuits, field programmable gate arrays (FPGAs) computers or the like.

All of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

The software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, while the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

Clause 1. A method, the method comprising: receiving a request to open a starting interface within a browser; identifying a cluster that includes a plurality of webpages from a browser history by determining that the plurality of webpages relate to a query; in response to identifying the cluster, generating a user interface for the cluster, the user interface including a first region displaying a first webpage title and a first image from a first webpage of the plurality of webpages, the first region being selectable to navigate to an address for the first webpage, and a second region displaying a second webpage title from a second webpage of the plurality of webpages, the second region being selectable to navigate to an address for the second webpage; and causing display of the user interface in the starting interface.

Clause 2. The method of clause 1, wherein the cluster is further identified by determining that a webpage of the plurality of webpages is associated with a first page access time that is within a time threshold.

Clause 3. The method of any preceding clause, wherein in response to identifying the cluster the method further includes obtaining a related search suggestion for a cluster topic for the cluster; and the user interface for the cluster further includes a third region displaying the related search suggestion, the third region being selectable to initiate a search using the related search suggestion.

Clause 4. The method of any preceding clause, wherein the starting interface is a new tab page.

Clause 5. The method of any preceding clause, wherein the first webpage is associated with a higher ranking than a ranking of the second webpage, and wherein the first webpage is assigned to the first region based on the higher ranking.

Clause 6. The method of any one of clauses 1 to 4, wherein the first webpage is selected for the first region based on properties of a first image meeting user interface inclusion criteria.

Clause 7. The method of preceding clause, wherein the second region includes a second image, and the first region is displayed with a first size based on a first property of the first image, and the second region is displayed with a second size based on a second property of the second image.

Clause 8. The method of any one of clauses 1 to 6, wherein the first region has a first size and the second region has a second size, the first size and the second size being based on a quantity of other portions included in the user interface.

Clause 9. The method of any preceding clause, wherein the cluster is further identified by determining that a cluster topic is one that has been searched across two or more browsing sessions.

Clause 10. The method of any preceding clause, wherein the cluster is a first cluster and the user interface is a first user interface, the method further comprising: identifying a second cluster; in response to identifying the second cluster, generating a second user interface for the second cluster; and causing display of the second user interface with the first user interface in the starting interface.

Clause 11. The method of any preceding clause, further comprising: determining that the first webpage is associated with a list of saved items; and including a fourth region in the user interface, the fourth region including an indication of the list of saved items.

Clause 12. The method of clause 11, wherein the list of saved items is a collection of bookmarks, the indication indicating the first webpage is bookmarked in the browser.

Clause 13. The method of clause 11, wherein the list of saved items is a collection of annotations, the indication indicating the first webpage has an associated annotation.

Clause 14. The method any preceding clause, wherein the method further comprising, displaying a control configured to open a new tab group, the new tab group including a first tab displaying the first webpage and a second tab displaying the second webpage.

Clause 15. The method any preceding clause, further comprising: determining that a cluster category is not included in a category exclusion list.

Clause 16. The method any preceding clause, further comprising: determining that a cluster category is associated with a category that is included in a category inclusion list before displaying it in the starting interface.

Clause 17. A system comprising: a processor; and a memory configured with instructions to: receive a request to open a starting interface within a browser, identify a cluster that includes a plurality of webpages from a browser history by determining that the plurality of webpages relate to a query, and in response to identifying the cluster: obtain a related search suggestion for a cluster topic for the cluster, and generate a user interface for the cluster, the user interface including: a first region displaying a first webpage title and a first image from a first webpage of the plurality of webpages, the first region being selectable to navigate to an address for the first webpage, and a second region displaying a second webpage title from a second webpage of the plurality of webpages, the second region being selectable to navigate to an address for the second webpage; and cause display of the user interface in the starting interface.

Clause 18. The system of clause 17, wherein the cluster is further identified by determining that a webpage of the plurality of webpages is associated with a first page access time that is within a time threshold.

Clause 19. The system of clause 17 or 18, wherein the memory is further configured with instructions to obtain a related search suggestion for a cluster topic for the cluster, and the user interface for the cluster further includes a third region for displaying the related search suggestion, the third region being selectable to initiate a search using the related search suggestion.

Clause 20. The system of clause 17 or 18, wherein the first webpage is associated with a higher ranking than a ranking of the second webpage, and wherein the first webpage is assigned to the first region based on the higher ranking.

Clause 21. The system of any one of clauses 17 or 18, wherein the first webpage is selected for the first region based on properties of a first image meeting user interface inclusion criteria.

Clause 22. The system of any one of clauses 17 to 21, wherein the second region includes a second image, and the first region is displayed with a first size based on a first property of the first image, and the second region is displayed with a second size based on a second property of the second image.

Clause 23. The system of any one of clauses 17 to 21, wherein the first region has a first size and the second region has a second size, the first size and the second size being based on a quantity of other portions included in the user interface.

Clause 24. The system of any one of clauses 17 to 23, wherein the cluster is further identified by determining that the cluster topic is one that has been searched across two or more browsing sessions.

Clause 25. The system of any one of clauses 17 to 24, wherein the cluster is a first cluster and the user interface is a first user interface, and the memory is further configured with instructions to: identify a second cluster; in response to identifying the second cluster, generate a second user interface for the second cluster; and causing display of the second user interface with the first user interface in the starting interface.

Clause 26. The system of any one of clauses 17 to 25, wherein the memory is further configured with instructions to: determine that the first webpage is associated with a list of saved items; and include a fourth region in the user interface, the fourth region including an indication of the list of saved items.

Clause 27. The system of any one of clauses 17 to 26, wherein a list of saved items is a collection of bookmarks, the indication indicating the first webpage is bookmarked in the browser.

Clause 28. The system of any one of clauses 17 to 27, wherein the list of saved items is a collection of annotations, the indication indicating the first webpage has an associated annotation.

Clause 29. The system of any one of clauses 17 to 28, wherein the memory is further configured with instructions to: display a control configured to open a new tab group, the new tab group including a first tab displaying the first webpage and a second tab displaying the second webpage.

Clause 30. The system of any one of clauses 17 to 29, wherein the memory is further configured with instructions to: determine that a cluster category is not included in a category exclusion list.

Clause 31. The system of any one of clauses 17 to 30, wherein the memory is further configured with instructions to: determine that a cluster category is associated with a category that is included in a category inclusion list before displaying it in the starting interface.

Clause 32. A method comprising: determining a ranking signal for a cluster that includes a plurality of webpages from a browser history based on an attribute of members of the cluster; determining a cluster relevance rating based on the ranking signal; and upon determining that the cluster relevance rating is greater than a cluster relevance threshold value, generating a user interface for the cluster.

Clause 33. The method of clause 32, wherein the attribute of the members of the cluster is based on a portion of the browser history within a time threshold.

Clause 34. The method of any one of clauses 32 to 33, wherein the attribute of the members of the cluster is based on an access time.

Clause 35. The method of any one of clauses 32 to 34, further comprising: receiving a request to open a starting interface within a browser; and causing display of the user interface in the starting interface.

Clause 36. The method of any one of clauses 32 to 35, wherein the cluster relevance rating is determined using a machine-learned model using the ranking signal as input.

Clause 37. The method of any one of clauses 32 to 36, further comprising: obtaining a related search suggestion for a cluster topic for the cluster and displaying the related search suggestion in the user interface.

Clause 38. The method of any one of clauses 32 to 37, wherein identifying the cluster further includes determining that a cluster category is not included in a category exclusion list.

Clause 39. The method of any one of clauses 32 to 38, wherein determining the cluster relevance rating further includes increasing the cluster relevance rating upon determining that a cluster category is included in a category boost list.

Clause 40. The method any one of clauses 32 to 39, wherein the cluster includes a login webpage that is not displayed in the user interface.

Clause 41. The method any one of clauses 32 to 40, wherein the browser history is shared between two or more devices.

Clause 42. A system comprising: a processor; and a memory configured with instructions to perform: the method of any one of clauses 32-41.

What is claimed is:

1. A method, the method comprising:
receiving a request to open a starting interface within a browser;
identifying a cluster that includes a plurality of webpages from a browser history by determining that the plurality of webpages relate to a query;
in response to identifying the cluster, generating a user interface for the cluster, the user interface including a first region displaying a first webpage title and a first image from a first webpage of the plurality of webpages, the first region being selectable to navigate to an address for the first webpage; and
causing display of the user interface in the starting interface.

2. The method of claim 1, wherein the cluster is further identified by determining that a webpage of the plurality of webpages is associated with a first page access time that is within a time threshold.

3. The method of claim 1, wherein in response to identifying the cluster the method further includes obtaining a related search suggestion for a cluster topic for the cluster; and the user interface for the cluster further includes a third region displaying the related search suggestion, the third region being selectable to initiate a search using the related search suggestion.

4. The method of claim 1, wherein the starting interface is a new tab page.

5. The method of claim 1, wherein the first webpage is selected for the first region based on properties of a first image meeting user interface inclusion criteria.

6. The method of claim 1, the user interface for the cluster further including a second region displaying a second webpage title from a second webpage of the of webpages, the second region being selectable to navigate to an address for the second webpage.

7. The method of claim 6, wherein the first webpage is associated with a higher ranking than a ranking of the second webpage, and wherein the first webpage is assigned to the first region based on the higher ranking.

8. The method of claim 6, wherein the second region includes a second image, and the first region is displayed with a first size based on a first property of the first image, and the second region is displayed with a second size based on a second property of the second image.

9. The method of claim 6, wherein the method further comprising,
displaying a control configured to open a new tab group, the new tab group including a first tab displaying the first webpage and a second tab displaying the second webpage.

10. The method of claim 1, wherein the cluster is further identified by determining that a cluster topic is one that has been searched across two or more browsing sessions.

11. The method of claim 1, wherein the cluster is a first cluster and the user interface is a first user interface, the method further comprising:
identifying a second cluster;
in response to identifying the second cluster, generating a second user interface for the second cluster; and
causing display of the second user interface with the first user interface in the starting interface.

12. The method of claim 1, further comprising:
determining that the first webpage is associated with a list of saved items; and
including a fourth region in the user interface, the fourth region including an indication of the list of saved items.

13. The method of claim 12, wherein the list of saved items is a collection of bookmarks, the indication indicating the first webpage is bookmarked in the browser.

14. The method of claim 12, wherein the list of saved items is a collection of annotations, the indication indicating the first webpage has an associated annotation.

15. A system comprising:
a processor; and
a memory configured with instructions to:
receive a request to open a starting interface within a browser,
identify a cluster that includes a plurality of webpages from a browser history by determining that the plurality of webpages relate to a query, and
in response to identifying the cluster:
obtain a related search suggestion for a cluster topic for the cluster, and
generate a user interface for the cluster, the user interface including:
a first region displaying a first webpage title and a first image from a first webpage of the plurality of webpages, the first region being selectable to navigate to an address for the first webpage, and
a second region displaying a second webpage title from a second webpage of the plurality of webpages, the second region being selectable to navigate to an address for the second webpage; and
cause display of the user interface in the starting interface.

16. The system of claim 15, wherein the cluster is further identified by determining that a webpage of the plurality of webpages is associated with a first page access time that is within a time threshold.

17. The system of claim 15, wherein the memory is further configured with instructions to obtain a related search suggestion for a cluster topic for the cluster, and the user interface for the cluster further includes a third region for displaying the related search suggestion, the third region being selectable to initiate a search using the related search suggestion.

18. The system of claim 15, wherein the first webpage is associated with a higher ranking than a ranking of the second webpage, and wherein the first webpage is assigned to the first region based on the higher ranking.

19. The system of claim 15, wherein the first webpage is selected for the first region based on properties of a first image meeting user interface inclusion criteria.

20. The system of claim 15, wherein the cluster is further identified by determining that the cluster topic is one that has been searched across two or more browsing sessions.

21. The system of claim 15, wherein the cluster is a first cluster and the user interface is a first user interface, and the memory is further configured with instructions to:
identify a second cluster;
in response to identifying the second cluster, generate a second user interface for the second cluster; and
causing display of the second user interface with the first user interface in the starting interface.

22. The system of claim 15, wherein the memory is further configured with instructions to:
determine that the first webpage is associated with a list of saved items; and
include a fourth region in the user interface, the fourth region including an indication of the list of saved items.

23. The system of claim 22, wherein a list of saved items is a collection of bookmarks, the indication indicating the first webpage is bookmarked in the browser.

24. The system of claim 22, wherein the list of saved items is a collection of annotations, the indication indicating the first webpage has an associated annotation.

25. The system of claim 15, wherein the memory is further configured with instructions to:
display a control configured to open a new tab group, the new tab group including a first tab displaying the first webpage and a second tab displaying the second webpage.
